(19) United States
(12) Patent Application Publication
(10) Pub. No.: US 2004/0071539 A1
(43) Pub. Date: Apr. 15, 2004

(54) Automated container management system

(76) Inventors: Raymond J. Anater JR., Lancaster, PA (US); Charles C. Gales, Lancaster, PA (US); Mark A. Killian, Lancaster, PA (US)

Correspondence Address: Barley, Snyder, Senft & Cohen, LLC, 126 East King Street, Lancaster, PA, 17602-2893, US

(21) Appl. No.: 10/613,618

(22) Filed: Jul. 3, 2003

Related U.S. Application Data
(60) Provisional application No. 60/394,005, filed on Jul. 3, 2002.

(51) Int. Cl. B65G 57/04; B65G 59/04

(52) U.S. Cl. 414/793.2; 414/796.4; 414/797.1; 294/65.5

(57) ABSTRACT

An automated container management system including at least one robotic device, a container inverting apparatus, a conveyor system, a container stack, and a storage and retrieval system transfer vehicle. The first and second robotic devices each having a container cooperation head. The container cooperation head has pneumatically driven magnetic lift assemblies for stacking and unstacking multiple containers as a single unit between the conveyor system and the container stack. The container storage and retrieval system transfer vehicle services the container stack. An inverting apparatus inverts the multiple containers before stacking and after unstacking to facilitate storage of the multiple containers in an inverted position.

### CROSS REFERENCE TO RELATED APPLICATION

This reference claims the benefit of U.S. Provisional Application Ser. No. 60/394,005, filed Jul. 3, 2002.

### FIELD OF THE INVENTION

The invention relates to an automated container management system that incorporates robotic stacking and unstacking of containers. More particularly, the invention relates to robotic devices provided with container cooperation heads that cooperate with surfaces of containers to stack and unstack the containers wherein the containers may be inverted to facilitate the operation of the system.

### BACKGROUND OF THE INVENTION

In the baking industry as well as other industries, companies are continually required to reduce price in order to stay competitive. It is not sufficient to merely analyze material costs, the cost of production must also be taken into consideration and be driven down. All costs, including production handling costs and storage costs, must be made cost-effective. One method to eliminate cost and improve efficiency is to utilize automated container management systems, both during production and in warehousing. These automated container management systems allow for personnel reductions, greater effective floor capacity, and increased production. One example of an automated container management system is an automated container storage and retrieval system disclosed in a brochure entitled “Take Control with Emtrol—Automated Pan and Trough Storage—Retrieval Systems.” While this automated container management system is shown for use in the baking industry, the concepts utilized therein may be adapted for use in any industry in which inventory needs to be stored and retrieved.

Problems arise in that loads handled by the automated container management systems are not specifically designed to make the automated container management system operate more effectively. Rather, the loads are generally designed to function with production equipment that produces the finished goods or for optimum performance of materials. For example, in the baking industry, the loads may consist of baking pans or containers. The containers are dimensioned to work with the baking or processing equipment and to allow optimum use of dough or other materials used in the baking process. The dimensions of the containers are not and cannot be governed by automated container management systems. Consequently, the automated container management system must be designed around the load design.

It is therefore desirable to design an automated container management system wherein the automated container management system is capable of operating with containers of various shapes and sizes without requiring significant down time to alter the machinery. It is also desirable to design an automated container management system wherein the automated container management system is capable of operating with lids and other objects used in industrial applications without requiring significant down time to alter the machinery.

### SUMMARY OF THE INVENTION

The invention relates to an automated container management system. The automated container management system includes at least one robotic device having a container cooperation head. The container cooperation head has magnetic lift assemblies for stacking and unstacking multiple containers as a single unit between a container stack and a conveyor system. The automated container management system may include an inverting apparatus that inverts the multiple containers before stacking and after unstacking and a container storage and retrieval system transfer vehicle that services the container stack.

The invention further relates to a method for storing containers, in particular bread pans. The method includes advancing multiple bread pans toward an inverting apparatus with an open side facing upward immediately after the bread pans leave a bread removal process with a conveyor assembly. The multiple bread pans are inverted with the inverting apparatus such that the open side faces downward. The multiple bread pans having the open side facing downward are transfered from the conveyor assembly to a container stack with a lift assembly of a robotic device. The multiple bread pans are stacked by the robotic device in a nested manner with the open side facing downward.

### BRIEF DESCRIPTION OF THE DRAWINGS

FIG. 1 is a top diagrammatic view of an automated container management system.

FIG. 2 is a front diagrammatic view of the automated container management system.

FIG. 3 is a side view taken along line 3-3 of FIG. 2.

FIG. 4 is a side view taken along line 4-4 of FIG. 2.

FIG. 5 is a top diagrammatic view of the automated container management system.

FIG. 6 is an elevational view of the first or second robotic device with a first embodiment of a container cooperation head.

FIG. 7 is a top perspective view of the first embodiment of the container cooperation head.

FIG. 8 is a bottom perspective view of the first embodiment of the container cooperation head.

FIG. 9 is a front perspective view of a magnetic gripper head of the first embodiment of the container cooperation head.

FIG. 10 is a cross-sectional view of the magnetic gripper head of FIG. 9 in a second position.

FIG. 11 is a cross-sectional view of the magnetic gripper head of FIG. 9 in a first position.

FIG. 12 is a side diagrammatic view of the first embodiment of the inverting apparatus receiving a container and an inclined surface of the conveyor system.

FIG. 13 is a side diagrammatic view of the first embodiment of the inverting apparatus inverting the container of FIG. 12 onto the inclined surface of the conveyor system.

FIG. 14 is a top perspective view of an alternate embodiment of the container cooperation head.

FIG. 15 is an elevational view of an alternate embodiment of the inverting apparatus.

FIG. 16 is a cross-sectional view of the alternate embodiment of the container cooperation head.

### DETAILED DESCRIPTION OF THE INVENTION

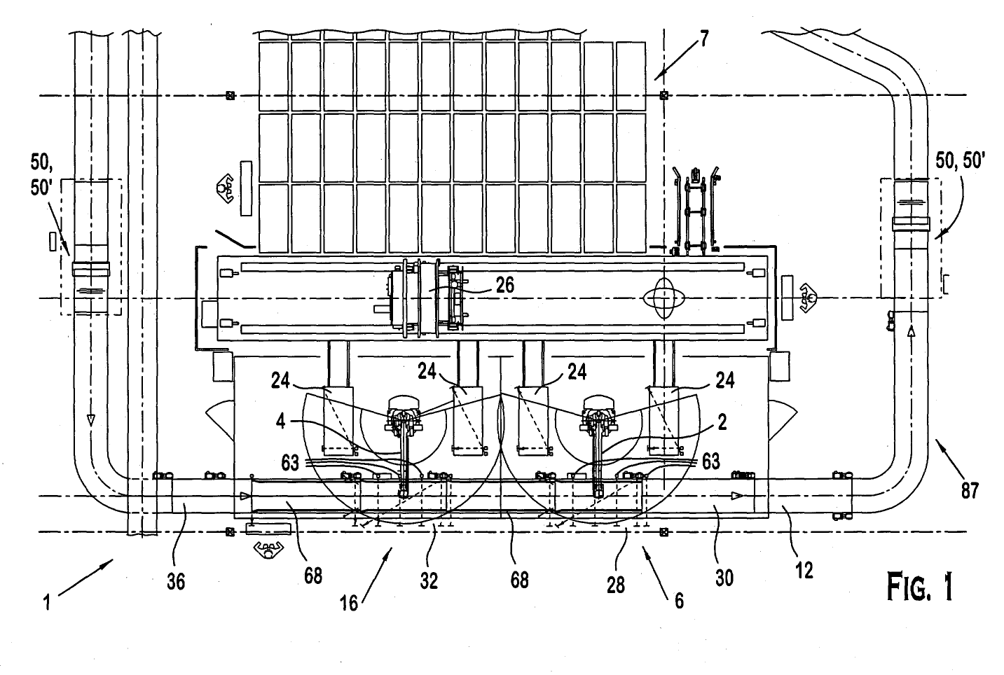

FIGS. 1 and 2 show an automated container management system 1. The automated container management system 1 has two physically and electronically separated first and second robotic devices 2, 4. Each of the first and second robotic devices 2, 4 can function as a stacker or an unstacker. In the embodiment shown, the first robotic device 2 unstacks containers 8 from a container stack 18 and moves the containers 8 to a first conveyor assembly 6 provided proximate the first robotic device 2. Although the embodiment shows baking containers 8, specifically bread pans, used in the automated container management system 1, the invention is not limited thereto; lids, other containers, and other objects capable of being conveyed by the first robotic device 2 may also be used in the automated container management system 1 without departing from the scope of the invention. The containers 8 are released from the first robotic device 2, as will be more fully described, and positioned on the first conveyor assembly 6. The first conveyer assembly 6 transports the containers 8 from the first robotic device 2 to other stations where the containers 8 are used in a baking process or other appropriate process. As the containers 8 are transported, the containers 8 may be inverted utilizing an inverting apparatus 50 shown in FIG. 4.

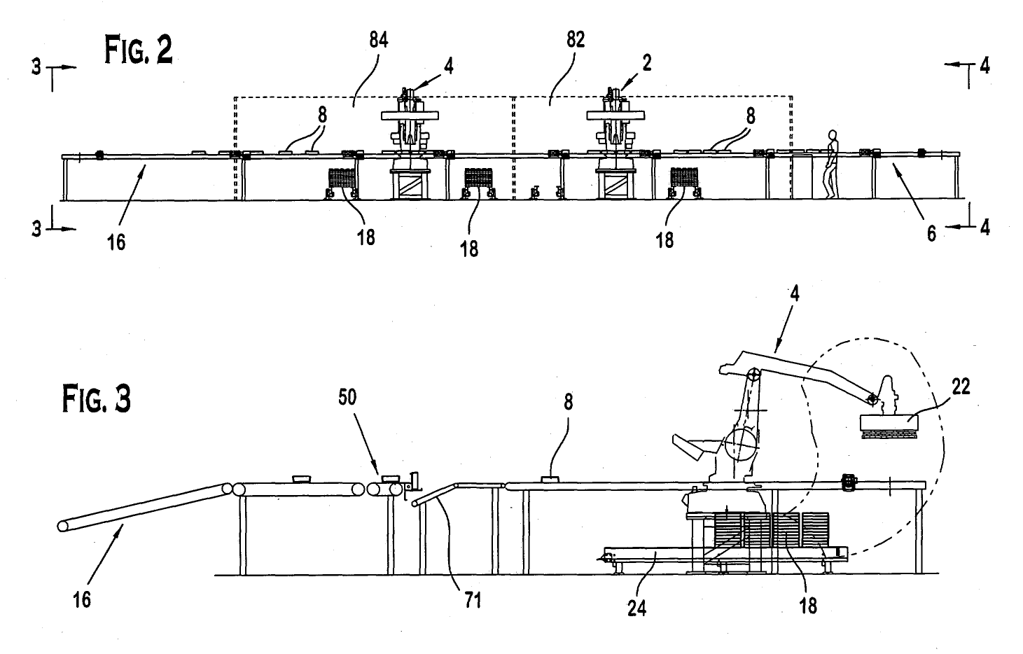

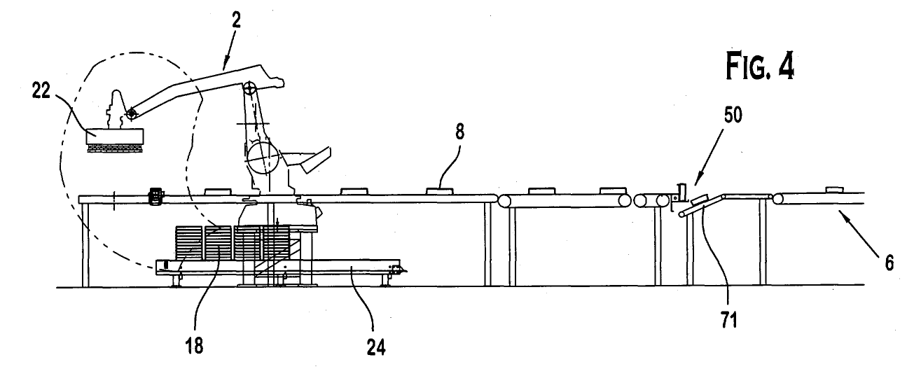

A second conveyer assembly 16 transports the containers 8 to the second robotic device 4 from other stations where the containers 8 are cleaned or utilized in a baking process or other appropriate process. The second conveyor assembly 16 is provided proximate the second robotic device 4. The second robotic device 4 removes the containers 8 from the second conveyor assembly 16 and moves the containers 8 to the respective container stack 18. The containers 8 are released from the second robotic device 4, as will be more fully described, and positioned on the respective container stack 18. As the containers 8 are transported, the containers 8 may be inverted utilizing the inverting apparatus 50 shown in FIG. 3. The inverting of the containers 8 enable the containers 8 to be more effectively stacked and stored until needed.

The individual elements of the automated container management system 1 will now be described in greater detail. The first and second robotic devices 2, 4 may be any industrial robotic devices that may be integrated to perform the functions described herein. Although two robotic devices 2; 4 are discussed herein, since each of the first and second robotic devices 2,4 can function as a stacker or an unstacker, any number of robotic devices may be used depending on the desired need of each individual system without departing from the scope of the invention. The first and second robotic devices 2, 4 preferably offer low noise levels and long intervals between routine maintenance. The first and second robotic devices 2, 4 may include such features as a multiple axis rigid cast steel articulated arm with double bearing joints, maintenance-free gearboxes, brushless AC servo motors, independent brakes on all axes, and integrated and enclosed cables.

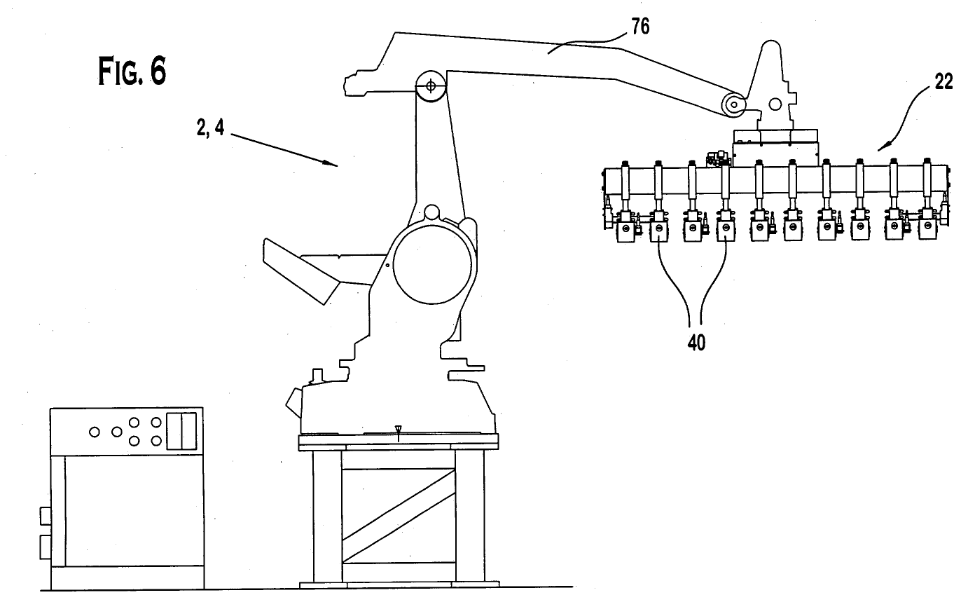

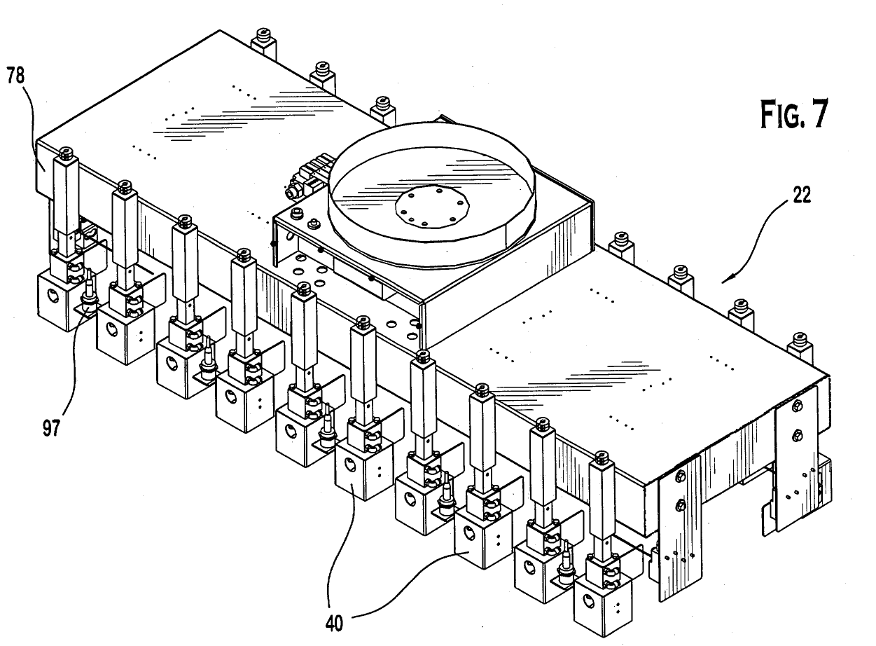

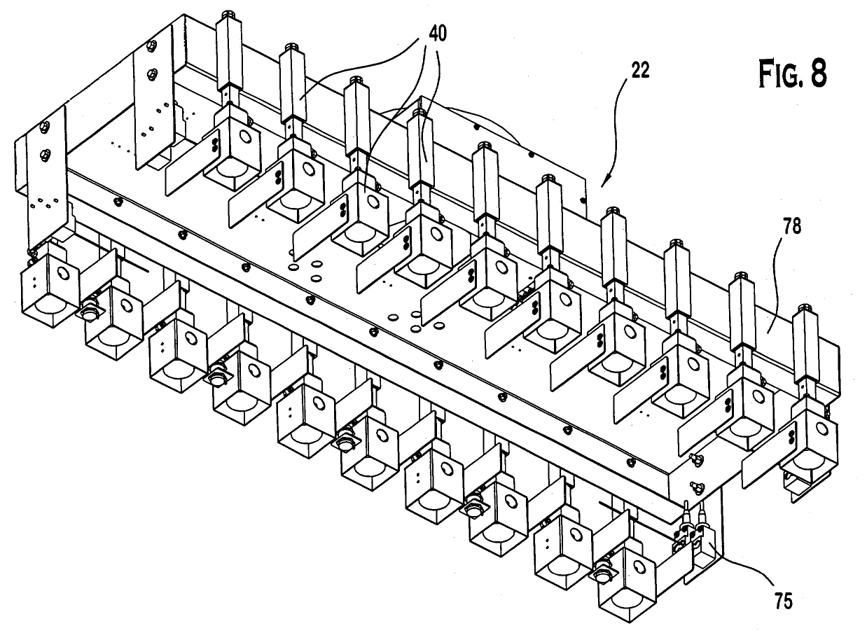

Each of the first and second robotic devices 2, 4 are fitted with a container handling end effector or container cooperation head 22, 22′. FIGS. 6 through 11 show a first embodiment of the container cooperation head 22. As best shown in FIG. 6, the container cooperation head 22 is connected to an end of a robotic manipulator 76 that extends from each of the first and second robotic devices 2, 4. The container cooperation head 22 is attached to the robotic manipulator 76 in such a manner so as to allow the container cooperation head 22 to rotate about a vertical axis relative to the robotic manipulator 76 such that the container cooperation head 22 may be aligned with the containers 8 while the containers 8 are stacked, removed from, and positioned on the first and second conveyor assemblies 6, 16. As shown in FIGS. 7 and 8, the container cooperation head 22 is provided with a plurality of magnetic gripper heads 40. The magnetic gripper heads 40 are arranged on either side of a base 78 of the container cooperation head 22. In the embodiment shown, each of the container cooperation heads 22 has four magnetic gripper heads 40 provided for each of the corresponding containers 8. Photoelectric sensors 75 are arranged at distal ends of the base 78 for monitoring vertical movement of the magnetic gripper heads 40.

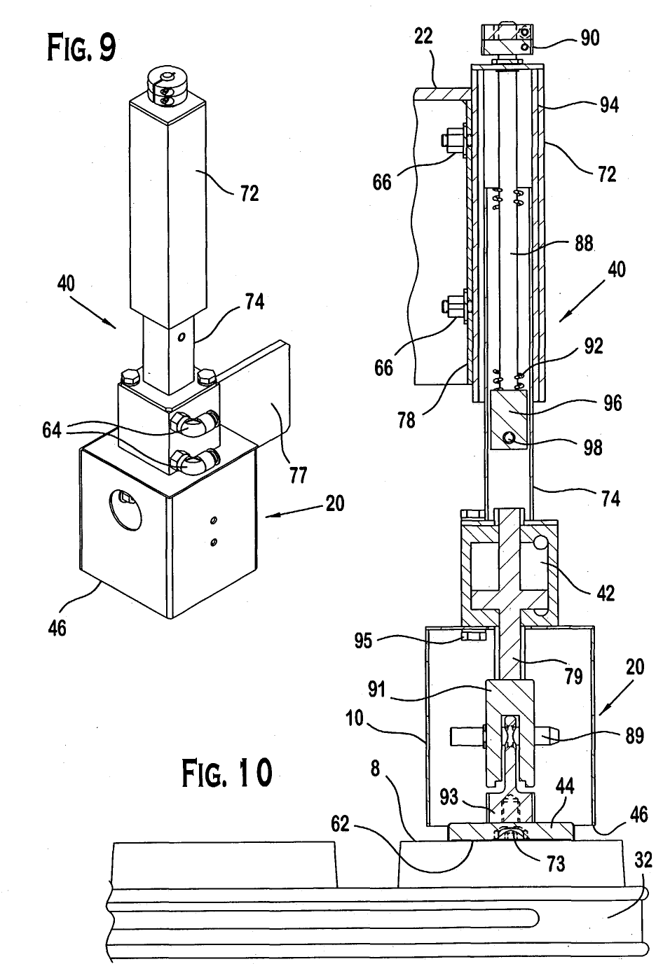

As best shown in FIGS. 9 through 11, each of the magnetic gripper heads 40 has a first housing 72, a second housing 74, an air cylinder 42, and a magnetic lift assembly 20. The first housing 72 is provided with studs 66 for mounting the magnetic gripper head 40 to a base 78 of the container cooperation head 22. A connecting rod 88 extends inside the first housing 72 and is held in place by a collar 90 positioned adjacent to a top surface of the first housing 72. A compression spring 92 is arranged about the connecting rod 88. At an end of the connecting rod 88 opposite the collar 90 is an element 96 with a pin 98. The second housing 74 extends into the first housing 72 and is connected thereto by the pin 98. A wear strip 94 is positioned between an inside surface of the first housing 72 and an outside surface of the second housing 74 to facilitate vertical movement therebetween.

The air cylinder 42 has a first end attached to the second housing 74 and a second end attached to the magnet lift assembly 20 by an attachment means, such as a screw, bolt, etc. The air cylinder 42 has a piston 79 that is driven in an upward and downward direction within the air cylinder 42. A distal end of the piston 79 is attached to the magnetic lift assembly 20. A plurality of elbows 64 is arranged on an outer surface of a housing of the air cylinder 42. The elbows 64 are arranged such that compressed air may be freely injected and exhausted from the air cylinder 42. A plate 77 extends from the outer surface adjacent the elbows 64 that corresponds with the photoelectric sensors 75 shown in FIG. 8 such that vertical movement of the plate is detected by the photoelectric sensors 75. As best shown in FIG. 7, a proximity sensor 97 is also arranged on the outside surface of the second housing 74. The proximity sensor 97 determines the presence of the containers 8 relative to the container cooperation head 22.

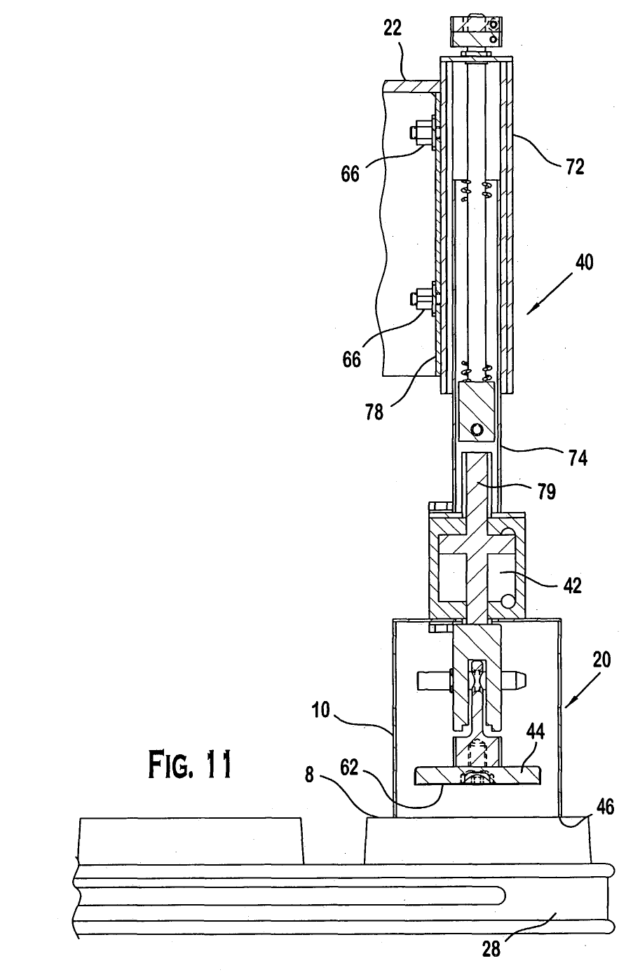

The magnetic lift assembly 20 includes a magnet housing 10 provided with a magnet 44 that is connected to the distal end of the piston 79. The magnet 44 is connected to the piston 79 in such a manner as to allow the magnet 44 to have free motion or float in at least two axes. In the embodiment shown, a base 91 is attached to the distal end of the piston 79. A support 93 is suspended from the base 91 by a pin 89. A magnet 44 is fixed to the support 93 by an attachment means 73, such as a screw, etc. The magnet 44 is driven by the piston 79 of the air cylinder 42 between a first position shown in FIG. 11 where the magnet 44 is positioned inside the magnet housing 10 and a second position shown in FIG. 10 where a bottom surface 62 of the magnet 44 extends beyond a fixed bottom surface 46 of the magnet housing 10.

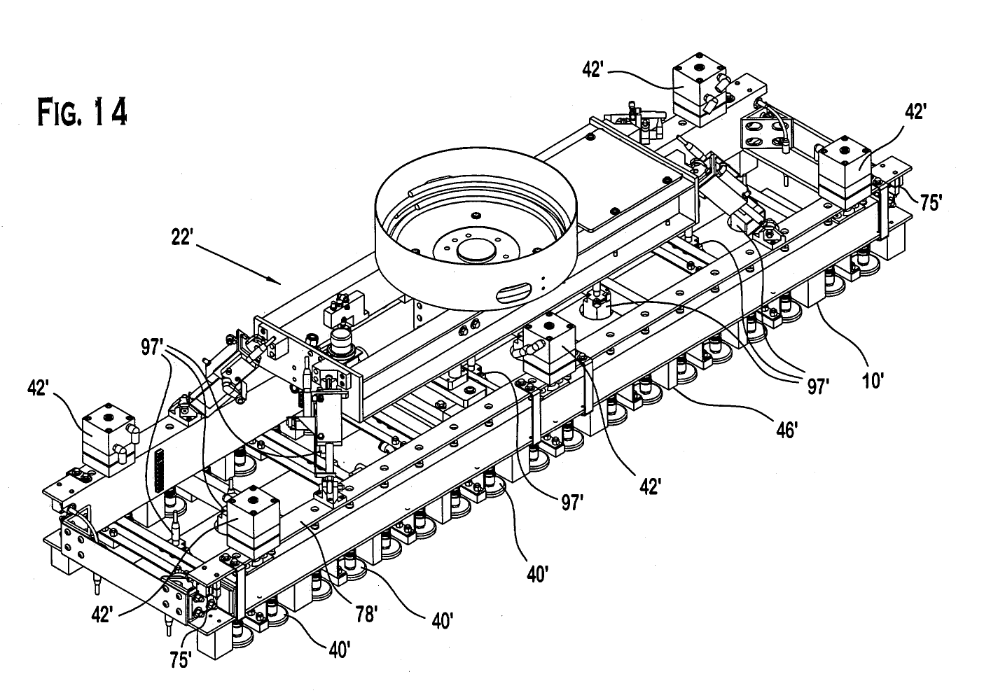

FIGS. 14 and 16 show an alternate embodiment of the container cooperation head 22′. The container cooperation head 22′ is attached to the robotic manipulator 76 (not shown) in the same manner, as the first embodiment. The container cooperation head 22′ is provided with a plurality of magnetic gripper heads 40′ attached to a base 78′ of the container cooperation head 22′. The magnetic gripper heads 40′ are arranged on either side of the container cooperation head 22′. In the embodiment shown, the container cooperation head 22′ has at least four of the magnetic gripper heads 40′ provided for each corresponding container 8. The magnetic gripper heads 40′ differ from the first embodiment in that a greater number of the magnetic gripper heads 40′ are arranged on the base 78′ of the second embodiment, and the magnetic gripper heads 40′ are arranged closer together than the magnetic gripper heads 40 of the first embodiment so that the container cooperation head 22′ may easily accommodate narrowly formed containers, lids, etc.

As best shown in FIG. 16, each of the magnetic gripper heads 40′ has a magnetic lift assembly 20′ provided with a magnet 44′ that has free motion or floats in at least two axes. In the embodiment shown, the magnet 44′ is connected to a self-aligning piston rod coupler 91′ by an attachment means 73′ such as a screw. The piston rod coupler 91′ is attached to a shoulder bolt 88′ that extends from the base 78′ of the container cooperation head 22′. A distal end of the shoulder bolt 88′ has a head 90′ similar to the collar 90 of the first embodiment that supports the magnet lift assembly 20′. A compression spring 92′ is arranged about the shoulder bolt 88′ and serves to keep the magnetic lift assembly 20′ in an extended position until the magnet 44′ is pushed upward by the surface of the container 8 during downward movement of the container cooperation head 22′. A plurality of dividers 10′ are arranged between each of the magnetic lift assembly 20′. Air cylinders 42′ are arranged along the base 78′ such that several of the air cylinders 42′ pneumatically drive a plurality of the magnets 44′ between a first position and a second position. In the embodiment shown, for example, three of the air cylinders 42′ drive a group of eighteen adjacently positioned magnets 44′. The magnets 44′ are driven by the air cylinder 42′ between a first position where a bottom surface 62′ of the magnets 44 is positioned above a fixed bottom surface 46′ of the adjacent dividers 10′ and a second position where the bottom surface 62′ of the magnets 44′ extends beyond a fixed bottom surface 46′ of the adjacent dividers 10′. Photoelectric sensors 75′ are arranged at distal ends of the base 78′ to monitor this vertical movement of the magnetic gripper heads 40′. The photoelectric sensors 75′ detect when any of the heads 90′ interrupts the light beam traveling between the photoelectric sensors 75′. Proximity sensors 97′ are arranged on the base 78′. The proximity sensors 97′ determine the presence of the containers 8 relative to the container cooperation head 22′.

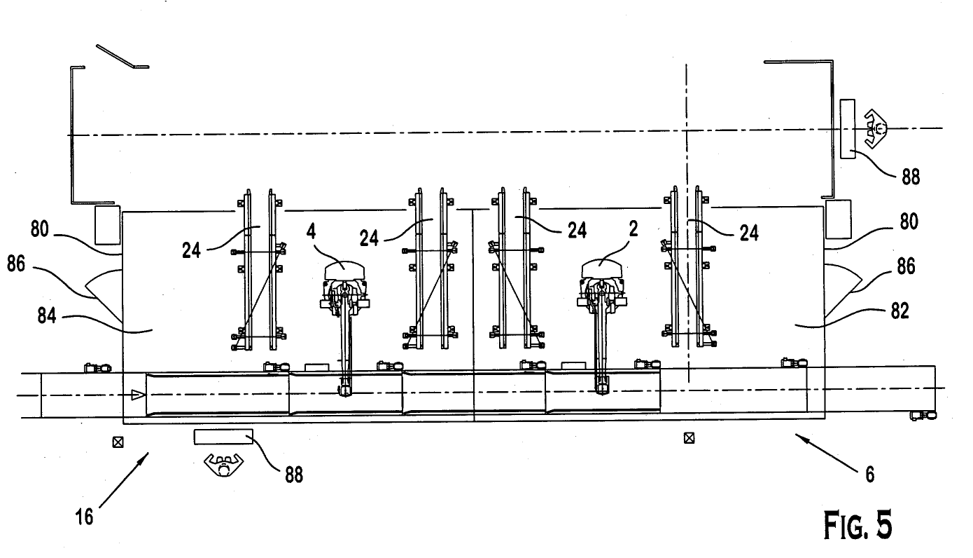

As best shown in FIGS. 2 and 5, each of the first and second robotic devices 2, 4 has a robotic device cell 82, 84, respectively. Each of the cells 82, 84 is provided with a series of the first and second conveyor assemblies 6, 16, a safety enclosure or fence 80, and two fixed or conveyorized container stacking stations 24 that are serviced by-a container storage and retrieval system 7 having a transfer vehicle 26 shown in FIG. 1. The transfer vehicle 26 is more fully described in U.S. Pat. No. 5,967,728, which is hereby incorporated by reference. The stacking stations 24 provided with each of the cells 82, 84 serve as supports for the container stacks 18 accessed by the corresponding first and second robotic devices 2, 4 and/or the transfer vehicle 26. On each of the stacking stations 24, multiple stacks of the containers 8 are positioned adjacent to each other with sides of the containers 8 in contact. The containers 8 are stacked on top of each other in a nested fashion.

As shown in FIG. 1, the first and second conveyor assemblies 6, 16 include a plurality of conveyors that make up a conveyor system 87. In the embodiment shown, the first conveyor assembly 6 has a grouping/discharge conveyor 28 and an outfeed metering conveyor 30 positioned adjacent thereto. Adjacent to the outfeed metering conveyor 30 is a manual load-on station 12. The second conveyor assembly 16 has a grouping/discharge conveyor 32 positioned between first and second accumulation conveyors 68, and an infeed metering conveyor 36 positioned adjacent to the first accumulation conveyor. As best shown in FIG. 1, the first and second conveyor assemblies 6, 16 are provided with sensors 63 for monitoring the containers 8.

As shown in FIG. 5, the safety enclosure 80 for each of the cells 82, 84 has an electrically interlocked access gate 86. When the access gate 86 is opened, the movement of the corresponding first or second robotic device 2, 4 is stopped to safeguard personnel from the possibility of being injured by the moving robotic devices 2, 4. An operator push-button station 88 is provided near the access gate 86 for each of the cells 82, 84. The operator pushbutton station 88 is equipped with a lockable robotic device disable switch that disables the corresponding first or second robotic device 2,4 while the operator is within the safety enclosure 80 for maintenance or corrective action. An emergency stop pushbutton is also provided. The access gate 86, lockable robotic device disable switch, and emergency stop pushbutton for each of the cells, 82, 84 only operate for the corresponding cell 82, 84, i.e., the adjacent robotic cell 82, 84 is not affected. Each of the operator pushbutton stations 88 has a request to enter selector switch. When the request to enter selector switch is activated, the affected first or second robotic device 2, 4 is programmed to complete the current task and move to a predefined position, which is easy to restart from. Each of the operator pushbutton stations 88 has an ok-to-enter lamp that illuminates when the affected robotic device 2, 4 is stopped at the predefined position and it is permissible to open the access gate 86. A box adjacent to the access gate 86 has a resume pushbutton to allow the operator to remotely restart the affected first or second robotic device 2, 4 after the access gate 86 is closed and the robotic device disable switch is returned to the auto position.

The first and second conveyor assemblies 6, 16 are preferably provided with a separate control panel so that the first and second conveying assemblies 6, 16 are independently powered from the first and second robotic devices 2, 4. The control panel may be any conventional control panel that may be integrated to perform the functions herein described. For example, the control panel may have a communications interface to communicate with the container storage and retrieval system and a communications interface to communicate with the robotic device controllers. An interface may also be used to control each of the first and second conveyor assemblies 6, 16.

The control element of each of the first and second robotic devices 2, 4 may be any conventional control element that may be integrated to perform the functions herein described, such as, an ABB S4C Controller. Control systems for each of the first and second robotic devices 2, 4, each of the transfer vehicles 26, and the first and second conveyor assemblies 6, 16 are tightly integrated to optimize equipment usage while stacking, unstacking, and re-circulating the containers 8. Either of the cells 82, 84 can perform the container 8 stacking or unstacking functions and can work in concert during container changeover conditions. The controller is designed to provide the highest level of operational reliability. The electronics and drives are preferably mounted in an enclosed ventilated cabinet with the drives fully protected against dust and dirt. The controller may feature safety interlocks, error-recovery procedures, and low energy consumption.

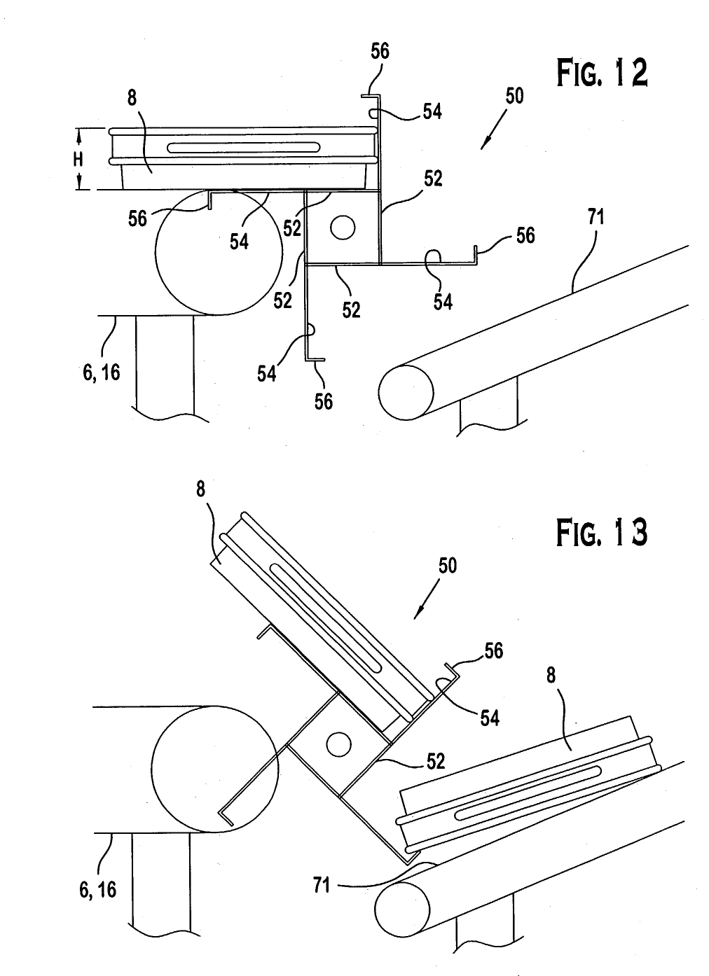

FIGS. 3-4 and 12-13 show a first embodiment of the container inverting apparatus 50. The inverting apparatus 50 is driven by a motor with associated controls and is positioned proximate the first and/or second conveyor assemblies 6, 16. As best shown in FIGS. 12 and 13, the inverting apparatus 50 has radially extending container engagement arms 52. Each of the arms 52 has a base 54. Each of the arms 52 extends essentially perpendicular from a base 54 of the adjacent arm 52. A containment plate 56 extends essentially perpendicular from the base 54 in a direction essentially parallel to the base 54 of an opposing arm 52. The containment plate 56 and the opposing arm 52 are spaced sufficiently to allow the containers 8 to be captured therebetween. In other words, the space between the containment plate 56 and the opposing arm 52 is greater than the height H of the containers 8. In the embodiment shown, the first and/or second conveyor assemblies 6, 16 have an inclined surface 71 positioned adjacent to the apparatus 50 for facilitating receipt of the containers 8 from the inverting apparatus 50.

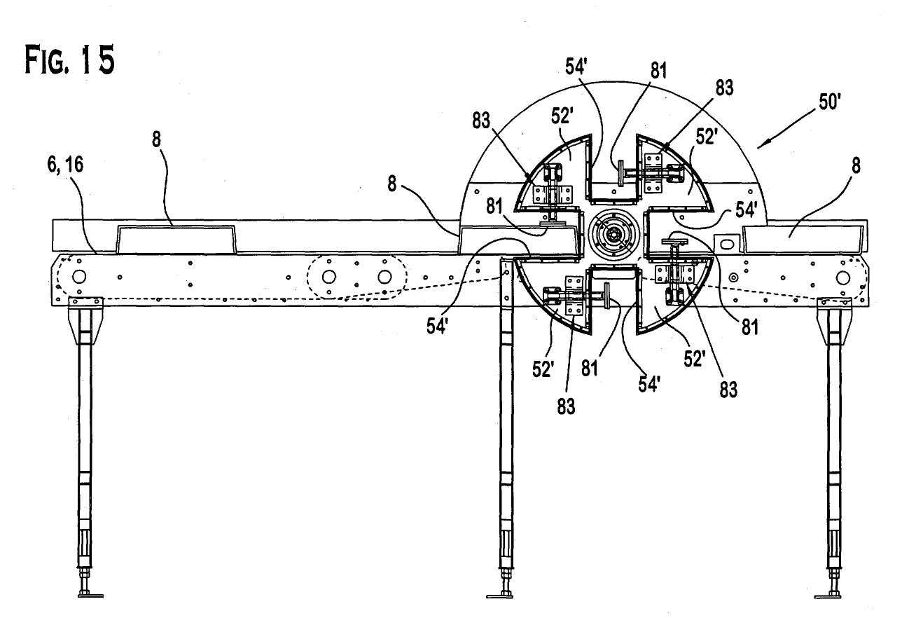

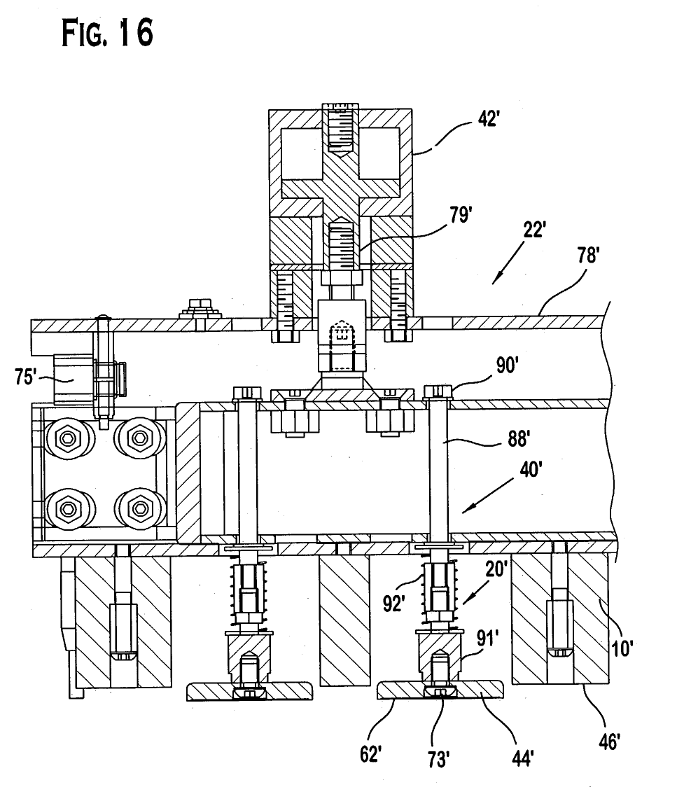

FIG. 15 shows an alternate embodiment of the container inverting apparatus 50′. The inverting apparatus 50′ is driven by a motor with associated controls and is positioned proximate the first and/or second conveyor assemblies 6, 16. The inverting apparatus 50′ has radially extending container engagement arms 52′. Each of the arms 52′ has a base 54′. The distance between the base 54′ of each of the arms 52′ and an opposing arm 52′ is greater than the height H of the containers 8 such that there is sufficient space to capture the containers 8 therebetween. The opposing arm 52′ is provided with a clamp assembly 83. The clamp assembly 83 is driven between a retracted position where a clamp 81 is positioned such that the container 8 may be advanced by the first or second conveyor assembly 6, 16 between the arm 52′ and the opposing arm 52′ and an extended position where the clamp engages a top surface of the container 8 to hold the container 8 in position while the arms 52′ are rotated to invert the containers 8 received therein. Although two embodiments of the inverting apparatus are described herein, it will be understood by those in the art that other inverting apparatuses may be used in the automated container management system 1 and still be in the scope of the invention.

The operation of the automated container management system 1 will now be described in greater detail. The operation of the automated container management system 1 will first be described utilizing the first embodiment of the container cooperation head 22 and the first embodiment of the inverting apparatus 50. The operation of the automated container management system 1 will then be described utilizing the second embodiment of the container cooperation head 22′ and the second embodiment of the inverting apparatus 50′.

Each of the robotic devices 2, 4 can function as a stacker or as an unstacker during line start-up, re-circulation, and line shutdown operations. In the embodiment shown in FIG. 1, the downstream or first robotic device 2 will function as an unstacker and the upstream or second robotic device 4 will function as a stacker. To place the containers 8 onto the first conveyor assembly 6; the operator selects the unstack automatic mode from the operator interface device provided with the automated container management system 1. As best shown in FIG. 4, the first robotic device 2 picks-up a row of the containers 8 off a top-of the container stacks 18 previously positioned on the container stacking stations 24 by the transfer vehicle 26. To pick-up the containers 8, the first robotic device 2 positions the container corporation head 22 substantially above a top of the container stack 18. Compressed air is then injected through one of the elbows 64 of the magnet gripper head 40 to cause the piston 79 to move downward such that the magnet 44 is moved from the first position shown in FIG. 11 to the second-position shown in FIG. 10. When the magnet 44 is in the second position, a bottom surface 62 of the magnet 44 is positioned below the fixed bottom surface 46 of the magnet housing 10. The container cooperation head 22 is lowered until the photoelectric sensors 75 on the magnetic heads 40 sense the movement of the magnetic gripper heads 40 as the magnets 44 engage the surface of the containers 8. Because the magnet 44 can move in at least two axes relative to the piston 79 of the air cylinder 42, the magnet 44 can compensate or conform to any deformities or irregularities in the surface of the containers 8. The compression spring 92 also enables the second housing 74 to be vertically compressed into the first housing 72 to allow for vertical compliance with uneven containers 8. Since a greater surface area of the magnet 44 can cooperate with the surface of the containers 8 and the magnet 44 is fully extended during pick-up of the containers 8, reliability of the container cooperation head 22 is increased and the precision of stacking and unstacking the containers 8 is also greatly increased.

Once the containers 8 are engaged with the magnets 44, the first robotic device 2 positions the container cooperation head 22 substantially -above the grouping/discharge conveyor 28 of the first conveyor assembly 6. When the containers 8 are in position for release, compressed air is directed to an opposite end of the cylinder 42 through the second elbow 64 to retract the piston 79. As the piston 79 is retracted, the magnet 44 returns to the first position shown in FIG. 11 where the magnet is positioned inside the housing 10. As the magnet 44 is retracted, the surface of the container 8 engages the fixed bottom surface 46 of the housing 10 resulting in the container 8 disengaging from the container cooperation head 22. The containers 8 are deposited onto the grouping/discharge conveyor 28 with sides of the containers 8 in contact. The containers 8 are conveyed by the grouping/discharge conveyor 28 out of the cell 82 and onto the outfeed metering conveyor 30 that is matched in speed to the nominal rate of the downstream processing equipment.

Normally, multiple containers 8 are picked-up at a time (one from each individual stack in the container stack 18), if the number of the containers 8 is the same in each of the container stacks 18. If for some reason the container stacks 18 are uneven, the first robotic device 2 picks from the highest to the lowest stack in the group until the container stacks 18 are even. In the process of leveling the container stacks 18, the first robotic device 2 picks the number of containers 8 equal to the number of container stacks 18 of equal height with each pick. When the container stacking station 24 is almost empty, the first robotic device 2 requests another load of the same container type from the container storage and retrieval system 7. The transfer vehicle 26 then delivers the requested containers 8 to the adjacent container stacking station 24. When the containers 8 are depleted from the stacking station 24, the first robotic device 2 automatically moves on to picking from the adjacent container stacking station 24. Whenever the first robotic device 2 picks from a new container stacking station 24, the first robotic device 2 first searches for the top containers 8 in the container stacks 18 at reduced speeds and then proceeds to locate subsequent containers 8 at normal speeds. The first robotic device 2 continues to place the containers 8 onto the first conveying assembly 6 whenever it is enabled and there is room to place a group of multiple containers 8 that equal the length of the container cooperation head 22.

After the containers 8 are conveyed by the first conveyor assembly 6 out of the cell 82, the containers 8 may be inverted by the inverting apparatus 50. For example, in the embodiment shown, the containers 8 are baking containers and are positioned by the robotic device 2 on the first conveyor assembly 6 with an open surface of the baking container positioned downward. The inverting apparatus 50 inverts the containers 8 so that the open surface of the baking container is positioned upward: The first conveyor assembly 6 advances rows or single containers 8 toward the inverting apparatus 50. The apparatus 50 is positioned such that the arm 52 is essentially parallel and level with the first conveyor assembly 6. In this position, the plate 56 is positioned above the first conveyor assembly 6. The containers 8 are advanced until a leading edge of the container 8 is received by the base 54. The apparatus 50 is then rotated. As the rotation occurs, subsequent containers 8 are loosely captured between the arm 52 and the plate 56. Rotation continues until the containers 8 are rotated between 90 degrees and 180, degrees. As the containers 8 approach 180 degrees of the rotation, gravity causes the containers 8 to fall from the apparatus 50 onto the inclined surface 71 of the first conveyor assembly 6. Consequently, the containers 8 are flipped or inverted from their original orientation. It will be appreciated and understood by those in the art that the rotation of the arm 52 and the degree of rotation may vary depending on the amount of arms 52 provided and the positioning of the adjacent conveyors 6, 16, 71 receiving the inverted containers 8. This process can be used to invert containers 8 that are carried on their base or top surface. The controller of the inverting apparatus 50 and the first and second conveyor assemblies 6, 16 are coordinated to allow the continuous operation of the inverting apparatus 50. After being inverted, the containers 8 are transported for use in the baking process or other appropriate processes.

After being used in the appropriate processes, the containers 8 are transported toward the second cell 84 by the second conveyor assembly 16. Before reaching the second cell 84, the containers 8 may be inverted back to their original storage orientation by another inverting apparatus 50 using the same process described above. After leaving the apparatus 50, the containers are transported toward the second cell 84 by the infeed metering conveyor 36 and the accumulation conveyor 68 of the second conveyor assembly 16. The containers 8 then pass onto the grouping/discharge conveyor 32 of the second conveyor assembly 16 positioned inside the second cell 84. To remove the containers 8 from the grouping/discharge conveyor 32, the second robotic device 4 picks-up multiple containers 8 at a time from the grouping/discharge conveyor 32 and places the containers 8 onto an empty or,partially full container stacking station 24 in substantially the same manner as described above. The second robotic device 4 automatically removes the containers 8 from the grouping/discharge conveyor 32 whenever it is enabled, there are multiple containers 8 available on the grouping/discharge conveyor 32, containers 8 are present in the accumulation conveyor 36, a high accumulate state is sensed from the downstream container conveyor system 87, and the second robotic device 4 is not in unstack mode, pause mode or manual mode. To start the sequence described above, the operator selects the stack automatic mode for the second cell 84 from the operator interface device. The containers 8 are stacked adjacent to each other with the sides of the containers 8 in contact. When the container stacking station 24 is stacked to a pre-designated height, the second robotic device 4 automatically begins to stack onto an adjacent empty container stacking station 24. A sensor is used to verify that the container stacking station 24 is empty. If the second robotic device 4 must stack to a non-empty container stacking station 24 after resuming from normal operation, the second robotic device 4 searches for a top of the container stacks 18 at a slow speed until the top of the container stacks 18 is sensed by the proximity sensors 97 on the magnetic heads 40, and then, proceeds to stack subsequent containers 8 at a normal speed.

The cell 84 infeed metering conveyor 36, accumulating conveyor 68, and grouping/discharge conveyor 32 counts, stages, and forms the multiple container group for the second robotic device 4 to remove from the grouping/discharge conveyor 32 when in the container stack-off mode or when the container return conveyor system 87 downstream of the cell 84 reaches a high accumulate state. Otherwise, the containers 8 pass through the cell 84 and continue to the next accumulation conveyor 68 in the conveyor system 87, which in the embodiment shown is connected to the grouping/discharge conveyor 28 of the first conveyor assembly 6. The sensors 63 deployed on the infeed-metering conveyor 36, accumulating conveyors 68, grouping/discharge conveyors 28, 32, and outfeed metering conveyor 30 sense the presence of double, single, or turned containers 8 and any mis-picks by the second robotic device 4 from the grouping/discharge conveyor 32. In addition, the proximity sensors 97 on the container cooperation head 22 sense the presence of each of the containers 8 and over-travel of any container cooperation head 22 position. The combination of these sensors 63, 97 is used in a coordinated fashion to optimize error recovery and to protect the cells 82, 84 and downstream equipment

During line container changeover operations, the upstream or first robotic device 2 takes on the function of an unstacker and the downstream or second robotic device 4 takes on the function of a stacker. If either of the first or second robotic devices 2, 4 should fault during a changeover condition, the remaining operating first or second robotic device 2, 4 may become the stacker. During this condition, production personnel, would use a container truck station supplied with the container storage and retrieval system 7 to bring the containers 8 over to the manual load-on station 12 and manually unstack the new container type onto the first and/or second conveyor assemblies 6, 16.

The operation of the automated container management system 1 will now be described with the second embodiment of the container cooperation head 22′. To pick-up the containers 8, the first-robotic-device 2 positions the container corporation head 22′ substantially above a top of the container stack 18 or the grouping/discharge conveyor 32 of the second conveyor assembly 16. Compressed air is then injected into the air cylinder 42′ to cause the magnet 44′ to move from the first position to the second position. When the magnet 44′ is in the second position, the bottom surface 62′ of the magnet 44′ is positioned below the fixed bottom surface 46′ of the dividers 10′of the magnetic lift assembly 20′. The container cooperation head 22′ is lowered until the photoelectric sensors 75′ on the base 78′ sense the movement of he magnetic gripper heads 40′ as the magnets 44′ engage the surface of the containers 8. Because the magnet 44′ can move in at least two axes relative to the base 78′, the magnet 44′ can compensate or conform to any deformities or irregularities in the surface of the containers 8. -Since a greater surface area of the magnet 44′ can cooperate with the surface of the containers 8, reliability of the container cooperation head 22′ is increased and the precision of stacking and unstacking the containers 8 is also greatly increased.

Once the containers 8 are engaged with the magnets 44′ , the first robotic device 2 positions the container cooperation head 22′ substantially above the container stack 18 or the grouping/discharge conveyor 28 of the first conveyor assembly 6. When the containers 8 are in position for release, compressed air is directed to an opposite end of the air cylinder 42′ to retract the piston 79′ causing the bottom surface 62′ of the magnet 44′ to move above the fixed bottom surface 46′ of the dividers 10′. As the magnet 44′ is retracted, the surface of the container 8 engages the fixed bottom surface 46′ of the dividers 10′ resulting in the container 8 disengaging from the container cooperation head 22′. The containers 8 are deposited onto the grouping/discharge conveyor 28 or the respective container stack 18 with sides of the containers 8 in contact.

The operation of the automated container management system 1 will now be described with the second embodiment of the inverting apparatus 50′. Rows or single containers 8 are advanced toward the inverting apparatus 50′ by the first or second conveyor assemblies 6, 16. The apparatus 50′ is positioned such that the arm 52′ is essentially parallel and level with the respective first or second conveyor assembly 6, 16 and the clamp 81 of the clamp assembly 83 is in a retracted position. The containers 8 are advanced until a leading edge of the container 8 is received on the base 54′. The clamp assembly 83 drives the clamp 81 to the extended position such that the clamp 81 engages the surface of the container 8. The inverting apparatus 50′ is then rotated. As the rotation occurs, subsequent containers 8 are captured between the arm 52′ and the clamp 81. Rotation continues until the containers 8 are rotated 180 degrees. When the containers 8 reach 180 degrees of rotation, the clamp assembly 83 returns the clamp 81 to the retracted position and the container 8 is advanced by the respective first or second conveyor assembly 6, 16. Consequently, the containers 8 are flipped or inverted from their original orientation. This process can be used to invert containers 8 that are carried on their base or top surface. The controller of the apparatus 50′ and the first and second conveyor assemblies 6, 16 are coordinated to allow the continuous operation of the inverting apparatus 50′.

The automated container management system 1 disclosed herein incorporates robotic stacking and unstacking of the containers 8, which has many advantages over a system that uses conventional hard automation unit machines for the same functions. The unique handling of the containers 8 by the robotic devices 2, 4 leads to a significant decrease in the number of container jams that occur in the stacking and unstacking process. The first and second robotic devices 2, 4 are integrated with the transfer vehicle 26 and the first and second conveyor assemblies 6, 16 to efficiently return the containers 8 to storage or back to processing. The simple design of the first and second robotic devices 2, 4 and the container cooperation heads 22, 22′ also provides a significant reduction in set-up time between production runs. In addition, the inverting apparatuses 50, 50′ may be provided in line with the first and second conveyor assemblies 6, 16 to manipulate the containers 8 as required.

The unique configuration of the container cooperation heads 22, 22′ and magnetic gripper heads 40, 40′ can handle multiple containers 8 at a time and, thus, the number of machine movements required by the robotic devices 2, 4 is greatly reduced from those required by a conventional unit machine. The use of the first and second robotic devices 2, 4 and the container cooperation heads 22, 22′ also creates a more stable load for storage by stacking the containers 8 as a layer. Conventional unit machines create a single stack and then combine it with other stacks to form a load for storage, which is inherently less stable than the layers created by the automated container management system i. Consequently, the automated container management system 1 disclosed herein minimizes the opportunities for stacks to become skewed as the stacks are separated from and combined with each other while moving to and from storage.

The containers 8 that are unstacked and stacked according to the present invention will have a significantly longer life than those stacked and unstacked using conventional hard automation unit machines. The smooth, gentle motion of the robotic devices 2, 4 is in direct contrast with rapid, sequential movement inherent with a conventional unit machine. As the robotic devices 2, 4 move multiple containers 8 at the same time, a high production rate can be maintained while greatly reducing the speed, force, impact and stress experienced by each of the containers 8 as the containers 8 are stacked and unstacked. Conventional machines also generate a consistently high level of noise since the containers 8 are rapidly stacked with high-speed metal-to-metal impact. The automated container management system 1 described herein moves at a much gentler and slower machine rate by simultaneously and precisely stacking multiple containers 8. This results in significant reduction in noise level.

Another advantage of the automated container management system 1 is that the first and second conveyor assemblies 6, 16 may be maintained at ground level. Conventional top-down stackers and unstackers require that conveyors, diverters, mergers, side guide adjustments and other devices be mounted approximately eight feet off the floor. This places them in an area that is inaccessible to operators and maintenance personnel. Not only is it more difficult to reach these devices, but containers, such as baking pans, are often stacked at a very high temperature since they have just left the oven. By keeping potential jam points at ground level, the automated container management system 1 makes it easier to tend to hot containers that may need to be repositioned within the system 1.

The inverting apparatuses 50, 50′ described herein also serve to increase the container 8 life by inverting the containers 8. When the container 8 is inverted and a top of the container 8 is used as a base for stacking, a much stronger support base is provided for the stacked containers 8. The containers 8 that are stacked with the open side facing up concentrate the entire weight of the stack on a few molds on the bottom of the stack. The inverting apparatuses 50, 50′ described herein allow for inverted stacking and storing of the containers 8 on a peripheral band of the container 8. The weight of the stack is thereby transmitted between the peripheral bands of adjacent containers 8 to ensure the highest level of stack integrity.

The benefits of the automated container management system 1 described herein will also increase the useful life of the containers 8. Typical container life ranges from two to six years depending on the amount of use experienced by the container 8. Container replacement costs can be attributed to conventional hard automation unit machines that stack and unstack containers. This is due to the high cycle rate and concentrated load exerted on the containers 8 by this equipment. The automated container management system 1 greatly reduces these problems by handling multiple containers at one time and stacking them upside down on the container peripheral band. Consequently, a minimal amount of containers will need to be replaced over time.

Food safety organizations have discouraged the storage of containers with the open side facing up. The typical bakery uses conventional unit machines to stack and unstack containers 8 with the open side facing up. In response to food safety concerns, some bakeries utilize an operator to invert the top container of each stack prior to storage. This requires the operator to be near the stacking and unstacking machines, to turn over the top container 8 prior to storing the group of containers 8. As a result, the top container 8 of each stack is no longer nested with the remainder of the stack and is more prone to falling off of the stack. When the containers 8 are to be unstacked, the operator must turn the containers 8 over again so that the open side is facing up. If the operator is not careful to nest the containers 8 back together, a jam will result in the unstacker. This problem is eliminated with the present invention.

Because the inverting apparatuses 50, 50′ turn the containers 8 upside down, the containers 8 no longer collect debris during conveying, stacking, and storage operations. In addition, loose debris from processes, such as baking, may be removed from the containers 8 in an inverted position. The containers 8 remain inverted until they are called for in the process area. The containers 8 remain right side up through the process, for example in the baking process to accept dough and through the proofing, baking and de-panning process. The inverting apparatuses 50, 50′, prior to the stacking operation, turn each container 8 over until it is needed in the process whereupon another inverting apparatus 50 turns each container 8 open side up after exiting the storage area. The containers 8 that re-circulate through the process and bypass the second robotic device 4 are still inverted for debris removal and then turned right side up again prior to the process area. This feature results in improved product quality and reduced consumer complaints due to foreign material in the finished product.

The foregoing illustrates some of the possibilities for practicing the invention. Many other embodiments are possible within the scope and spirit of the invention. For example, the container cooperation heads may also be provided with vacuum gripping means or clamping gripping means in addition to the magnetic gripping means disclosed herein. It is, therefore, intended that the foregoing description be regarded as illustrative rather than limiting, and that the scope of the invention is given by the appended claims together with their full range of equivalents.

What is claimed is:

1. An automated container management system, comprising:
a conveyor system for transporting multiple containers;
a container stack;
at least one robotic device having a container cooperation head, the container cooperation head having magnetic lift assemblies for stacking and unstacking multiple containers as a single unit between the conveyor system and the container stack; and
a container inverting apparatus that inverts the multiple containers before stacking and after unstacking.

2. The system of claim 1, further comprising a container storage and retrieval system that services the container stack.

3. The system of claim 2, wherein the container storage and retrieval system includes a transfer vehicle.

4. The system of claim 1, wherein the container inverting apparatus includes radially extending engagement arms, each engagement arm having a containment plate wherein the containment plate and an opposing engagement arm form a space to capture a container therebetween when the engagement arms are rotated about a central axis.

5. The system of claim 1, wherein the container inverting apparatus includes radially extending engagement arms wherein an opposing arm has a clamp assembly for engaging a surface of each of the containers before each of the containers is rotated about a central axis.

6. The system of claim 1, wherein the container cooperation head is attached to a robotic manipulator of the robotic device such that the container cooperation head rotates about a vertical axis relative to the robotic manipulator.

7. The system of claim 1, wherein each of the magnetic lift assemblies are pneumatically driven between a first position and a second position and in the first position a magnet for holding the multiple containers is positioned above a fixed bottom surface of the magnetic lift assembly and in the second position the magnet is positioned below the fixed bottom surface of the magnetic lift assembly such that when the magnetic lift assembly is driven from the second position to the first position, the multiple containers are released from the magnet by the fixed bottom surface of the magnetic lift assembly.

8. The system of claim 7, wherein each of the magnetic lift assemblies is pneumatically driven by a separate air cylinder.

9. The system of claim 7, wherein a plurality of the magnetic lift assemblies is pneumatically driven by a plurality of the air cylinders.

10. The system of claim 7, wherein a plurality of the magnetic lift assemblies is pneumatically driven by a single air cylinder.

11. The system of claim 1, wherein each of the magnetic lift assemblies has at least one magnet for holding the multiple containers, each of the magnets freely moves in at least two axes relative to a surface of the multiple containers.

12. The system of claim 1, wherein the container cooperation head includes at least one proximity sensor for sensing the presence of the multiple containers.

13. The system of claim 1, wherein the multiple containers are stacked on the container stack in a nested manner with an open-side facing downward.

14. The system of claim 1, wherein the container stack is arranged on a conveyorized container stacking station.

15. The system of claim 1, wherein the container stack is fixed stacking station.

16. The system of claim 1, wherein the container stack is formed to be manually repositioned by an operator.

17. The system of claim 1, wherein the containers are baking pans.

18. The system of claim 1, wherein each of the magnet lift assemblies includes a compression spring for vertical compensation of the magnetic lift assembly relative to a surface of the multiple containers.

19. The system of claim 18, wherein the container cooperation head includes a photoelectric sensor that senses when each of the magnetic lift assemblies is vertically compressed.

20. An automated container management system, comprising:
a conveyor system for transporting multiple containers;
a container stack;
at least one robotic device having a container cooperation head, the container cooperation head having a means for stacking and unstacking the multiple containers as a single unit between the conveyor system and the container stack;
a container storage and retrieval system that services the container stack; and
an inverting apparatus that inverts the multiple containers before stacking and after unstacking.

21. The system of claim 20, wherein the means for stacking and unstacking the multiple containers is a plurality of magnetic lift assemblies.

22. The system of claim 21, wherein each of the magnetic lift assemblies has at least one magnet for holding the multiple containers, each of the magnets freely moves in at least two axes relative to a surface of the multiple containers.

23. The system of claim 22, wherein each of the magnet lift assemblies includes a compression spring for vertical compensation of the magnetic lift assembly relative to a surface of the multiple containers.

24. The system of claim 23, wherein the container cooperation head includes a photoelectric sensor that senses when the magnetic lift assembly is vertically compressed.

25. The system of claim 22, wherein each of the magnetic lift assemblies is pneumatically driven between a first position and a second position and in the first position a magnet for holding the multiple containers is positioned above a fixed bottom surface of the magnetic lift assembly and in the second position the magnet is positioned below the fixed bottom surface of the magnetic lift assembly such that when the magnetic lift assembly is driven from the second position to the first position, the multiple containers are released from the magnet by the fixed bottom surface of the magnetic lift assembly.

26. The system of claim 25, wherein each of the magnetic lift assemblies is pneumatically driven by a separate air cylinder.

27. The system of claim 25, wherein a plurality of the magnetic lift assemblies is pneumatically driven by a single air cylinder.

28. The system of claim 25, wherein a plurality of the magnetic lift assemblies is pneumatically driven by a plurality of the air cylinders.

29. The system of claim 20, wherein the container cooperation head is attached to a robotic manipulator of the robotic device such that the container cooperation head rotates about a vertical axis relative to the robotic manipulator.

30. The system of claim 20, wherein the multiple containers are stacked on the container stack in a nested manner with an open-side facing downward.

31. The system of claim 20, wherein the container inverting apparatus includes radially extending engagement arms, each engagement arm having a containment plate wherein the containment plate and an opposing engagement arm form a space to capture a container therebetween when the engagement arms are rotated about a central axis.

32. The system of claim 20, wherein the container inverting apparatus includes radially extending engagement arms wherein an opposing arm has a clamp assembly for engaging a surface of each of the containers before each of the containers is rotated about a central axis.

33. The system of claim 20, wherein the containers are baking pans.

34. A method for storing bread pans, comprising:
advancing multiple bread pans with a conveyor assembly toward an inverting apparatus with an open side facing upward after the multiple bread pans leave a bread removal process;
inverting the multiple bread pans with the inverting apparatus such that the open side faces downward;
transferring the multiple bread pans having the open side facing downward from the conveyor assembly to a container stack with a lift assembly of a robotic device; and
stacking the multiple bread pans in a nested manner with the robotic device with the open side facing downward.

35. The method of claim 34, further comprising:
transferring the multiple bread pans having the open side facing downward from the container stack to the conveyor assembly with a lift assembly of another robotic device;
advancing the multiple bread pans with the conveyor assembly toward another inverting apparatus with an open side facing dwnward; and
inverting the multiple bread pans with the other inverting apparatus such that the open side faces upward.

36. The method of claim 35, further comprising storing the multiple bread pans with a container storage and retrieval system transfer vehicle.

37. The method of claim 35, wherein the lift assembly is magnetic.

38. The method of claim 35, further comprising storing the multiple bread pans with a conveyorized container stacking station.

39. The method of claim 35, further comprising storing the multiple bread pans with a manually re-positioned cart.

40. The method of claim 35, further comprising storing the multiple bread pans on a fixed stacking station.
